(19) United States
(12) Patent Application Publication
(10) Pub. No.: US 2006/0085758 A1
(43) Pub. Date: Apr. 20, 2006

(54) Desktop alert management

(76) Inventor: Dan Backus, Lawrenceville, GA (US)

Correspondence Address: LAVA Group Law by Smith & Frohwein, P.O. Box 88148, Atlanta, GA, 30356, US

(21) Appl. No.: 10/967,744

(22) Filed: Oct. 18, 2004

(51) Int. Cl. G06F 17/00

(52) U.S. Cl. 715/772

(57) ABSTRACT

Various embodiments of systems, methods, computer programs, etc. for managing desktop alerts on a computer system or device are provided. One embodiment comprises a desktop alert management system for controlling alerts displayed on a graphical user interface. One such desktop alert management system comprises: a message controller module for controlling communication between a graphical user interface and at least one source, the message controller module configured to receive a message from the at least one source; and an alert manager for determining an alert graphic associated with the message from the at least one source, the alert graphic to be displayed on the graphical user interface for a desktop alert associated with the message.

### BACKGROUND

Various computer systems and devices (e.g., personal computers, laptops, workstations, handheld devices, etc.) employ a display and an associated graphical user interface (GUI) for enabling a user to easily interact with the computer system via a variety of input devices. In general, a GUI comprises a program interface that takes advantage of the graphics capabilities of the computer system to make it easier for the user to perform tasks associated with computer applications, the operating system, etc. Typically, a GUI comprises an on-screen pointer and a pointing device that enables the user to interact with various types of graphical objects displayed on the display screen. The on-screen pointer often involves a symbol that appears on the display screen and which is moved via the pointing device (e.g., mouse, trackball, user's fingers, stylus, etc.). The on-screen pointer may be moved around the display screen to select or otherwise interact with various graphical objects to perform any of a variety of functions.

A typical GUI employs any combination of windows, icons, menus, folders, buttons, etc. to provide a user-friendly computing environment for enabling the user to interact with computer applications and programs stored on the computer system, as well as applications, programs, services, etc. provided to the computer system via a communications network. At any given time, several applications may be active on the computer system. For example, the user may be preparing a document using a word processing application in one window on the display screen. In another window, a web browser may be open for performing spontaneous research. An e-mail client may be minimized in the system tray, task bar, etc. (or otherwise masked from the visual real estate of the display screen). The user may also have an instant messaging application functionally active on the computer system, or a news reader for receiving various types of news, information, or other content of interest to the user.

Some of these types of applications include an application-specific feature for communicating various types of information to the user while the application is functionally active on the computer system. By way of example, the e-mail client may include an “inbox” icon in an active window for displaying new incoming messages. When the e-mail client is masked from the visual real estate of the display screen, incoming messages may be communicated to the user via icons displayed on a taskbar, toolbar, etc., or via pop-up windows, thought balloons, mouse-over windows, or other graphics and/or text. In a similar manner, the news reader may alert the user that new content is available. Other tools or utilities (e.g., a printer manager, a network connection tool, etc.) may employ this alert functionality to provide application-specific content to the user. In the case of a network connection tool, an associated icon on the taskbar or system tray may be changed from green to red when the computer system loses communication with a wireless network. A printer icon on the taskbar or system tray may display a text alert when the printer is out of paper.

As will be appreciated with reference to the description below, however, these and other existing desktop alert mechanisms have various limitations. Therefore, there is a need in the art for systems, methods, computer programs, etc. for managing desktop alerts in a computer system.

### SUMMARY

Various embodiments of systems, methods, computer programs, etc. for managing desktop alerts on a computer system or device are provided. One embodiment comprises a desktop alert management system for controlling alerts displayed on a graphical user interface. One such desktop alert management system comprises: a message controller module for controlling communication between a graphical user interface and at least one source, the message controller module configured to receive a message from the at least one source; and an alert manager for determining an alert graphic associated with the message from the at least one source, the alert graphic to be displayed on the graphical user interface for a desktop alert associated with the message.

Another embodiment is computer system comprising: a graphical user interface; and a desktop alert management module for controlling alerts provided to the graphical user interface, the desktop alert management module comprising: logic configured to receive a message associated with a source; logic configured to determine a parameter corresponding to the message; logic configured to determine an alert graphic associated with the parameter; and logic configured to provide the alert graphic to the graphical user interface.

Yet another embodiment is a method for providing alerts to a desktop. One such method comprises: receiving a message from a source; determining a message-related parameter corresponding to the message; and identifying an avatar associated with the message-related parameter.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram of one of a number of embodiments of a desktop alert management system.

FIG. 2 is a flow chart illustrating the general architecture, operation, and/or functionality of one embodiment of the desktop alert management system of FIG. 1.

FIG. 3 is a block diagram illustrating another embodiment of the desktop alert management system of FIG. 1.

FIG. 4 is a combined system diagram and screen shot illustrating the architecture, operation, and/or functionality of another embodiment of the desktop alert management system of FIG. 1.

FIG. 5 illustrates the graphical user interface of FIG. 4 after a first message is received from an exemplary source and an associated alert graphic is displayed.

FIG. 6 illustrates the graphical user interface of FIG. 5 after a second message is received from another source and an associated alert graphic is displayed.

FIG. 7 illustrates the graphical user interface of FIG. 6 after a user engages the alert graphic associated with the second message and a corresponding e-mail message is displayed in a thought balloon.

FIG. 8 illustrates another example of the graphical user interface of FIG. 6 after a user engages the alert graphic associated with the second message and the e-mail message is displayed in a separate application window.

FIG. 9 illustrates the graphical user interface of FIG. 5 after the e-mail message is reconciled and the alert graphic is removed.

FIG. 10 illustrates the graphical user interface of FIG. 9 after a third message is received from another source and an associated graphic is displayed.

FIG. 11 illustrates the graphical user interface of FIG. 10 and one embodiment of a graphics effect implemented to display the associated graphic.

FIG. 12 illustrates the graphical user interface of FIG. 11 as the user changes the location of the alert graphic.

FIG. 13 illustrates the graphical user interface of FIG. 12, in which the alert graphic employs a self-contained properties feature that enables the user to modify the alert properties.

FIG. 14 illustrates the graphical user interface of FIG. 13 in which the user has selected the “disable alert” feature.

FIG. 15 illustrates the graphical user interface of FIG. 14 after the alert graphic is disabled.

FIG. 16 illustrates the graphical user interface of FIG. 15 after a fourth message is received from another source and the associated alert graphic is layered with a previous alert graphic.

FIG. 17 illustrates the graphical user interface of FIG. 15 after a fifth message (having a lower alert level or priority than the fourth message) is received from another source and the associated alert graphic is layered behind the prior alert graphic.

FIG. 18 illustrates an alert group feature supported by an embodiment of a desktop alert management system.

FIG. 19 is a block diagram of another embodiment of a desktop alert management system.

### DETAILED DESCRIPTION

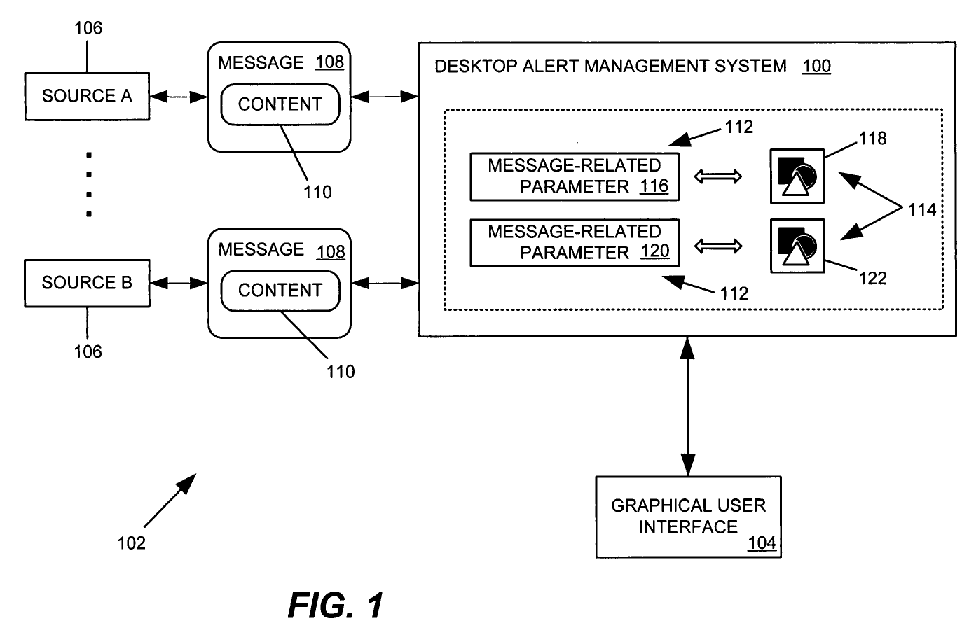

Various embodiments of systems, methods, computer programs, etc. for managing desktop alerts on a computer system or device are described below with reference to FIGS. 1-19. As an introductory matter, however, the general operation of one exemplary embodiment of a desktop alert management system will be briefly described. It should be appreciated that the term “desktop” refers to at least a portion of the display screen of the computer system. In general, the exemplary desktop alert management system resides on a computer system or device, and provides a global desktop resource for managing alerts, incoming messages, new content, etc. that are received from various sources. The sources may comprise any application, program, tool, utility, etc. by which electronic messages, alerts, information, multimedia content, or any other form of information may be provided to the user of the computer system via the graphical user interface.

The desktop alert management system receives messages (from the sources) which are to be presented to the user via the graphical user interface. In a broad sense, the messages comprise information to be presented to the user. For example, the messages may comprise any of the following, or other types of information: an application-related alert, a news event, an incoming e-mail message, or any other content intended to be viewed or accessed by the user of the computer system, regardless of the purpose. The desktop alert management system enables the user of the computer system (and/or the source) to control the manner in which desktop alerts associated with the messages will be provided to the graphical user interface.

For instance, rather than provide the messages directly to the display screen (or directly to a corresponding software application, etc. to be handled in the manner dictated by the application), the desktop alert management system displays a user-specified alert graphic or avatar on the display screen. The user-specified alert graphic or avatar (rather than the message itself) is provided on the display screen “above” any active windows or other graphics displayed on the graphical user interface. The user-specified alert graphic is predefined by the user of the computer system or the source of the message, and is specifically defined to represent the source of the message, content contained in the message, a content category, or any other message-related parameter. For example, the user of the computer system may configure the desktop alert management system to map e-mail messages received from a specific person to a particular alert graphic. Therefore, when an e-mail is received from that person, the desktop alert management system will display the alert graphic on the display screen. Similarly, a source may desire to be associated with a particular alert graphic, in which case the desktop alert management system may display the alert graphic when messages are received from the source.

It should be appreciated that, because the alert graphic is specified (by the user or source) to represent information about the corresponding message(s), the user of the computer system may easily and quickly decide whether or not to view the message. Furthermore, because of the underlying association created by the alert graphic, the desktop alert management system provides a less-intrusive and space-saving mechanism for alerting the user of messages.

FIG. 1 illustrates one embodiment of a computer system 102 in which one of a number of embodiments of a desktop alert management system 100 may be employed. As illustrated in FIG. 1, desktop alert management system 100 is embodied in a computer system or device (e.g., a personal computer, laptop, workstation, handheld device, etc.). Desktop alert management system 100 is functionally located between a graphical user interface 104 associated with the computer and one or more sources 106. Sources 106 may comprise any application, program, tool, utility, etc. capable of providing electronic messages, alerts, information, multimedia content, or any other form of information (collectively illustrated as messages 108). Messages 108 may include content 110 intended to be displayed on graphical user interface 104. It should be appreciated that messages 108 may be provided to desktop alert management system 100 using any desirable communication protocol, software mechanisms, etc.

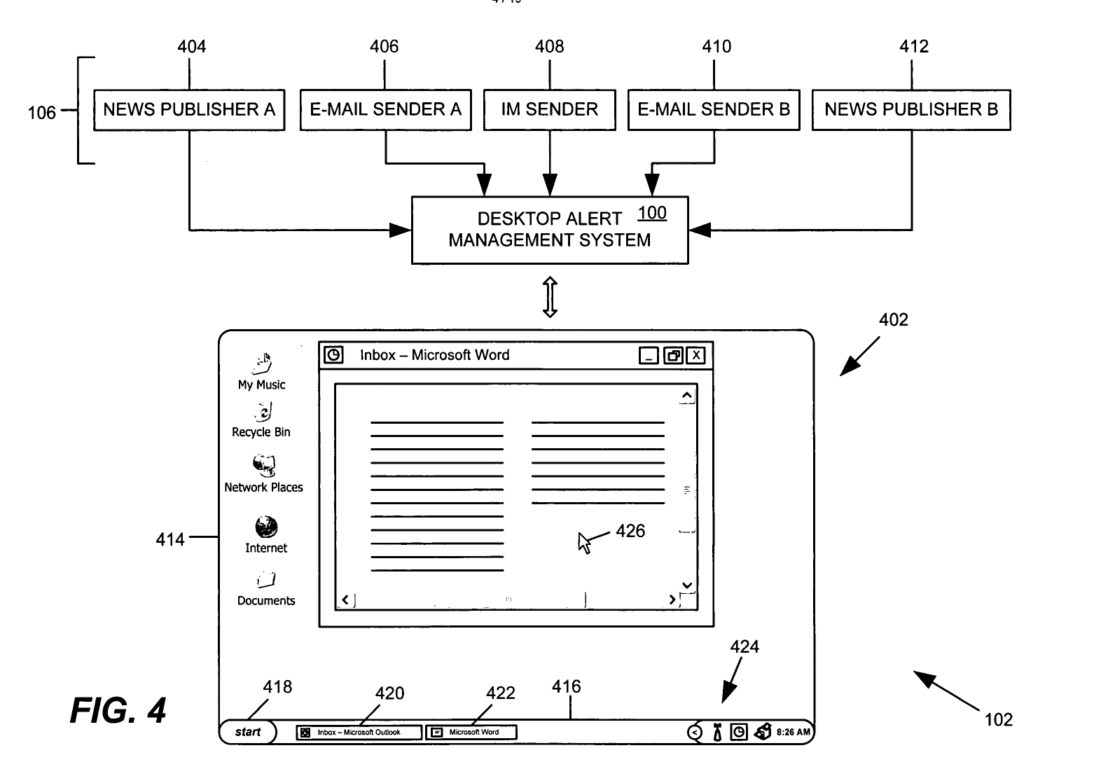

As further illustrated in FIG. 1, desktop alert management system 100 provides a means for mapping a message-related parameter 112 associated with a particular message 108 to a corresponding desktop alert (alert graphic 114). Desktop alert management system 100 uses this mapping to determine which desktop alert is to be displayed on graphical user interface 104 in response to any given message 108. In other words, when a particular message 108 is received, desktop alert management system 100 references the logical mapping and determines which alert graphic 114 to display. As described in more detail below with reference to FIGS. 4-19, the logical mapping may be defined by the user, the source, or any combination thereof. For example, in one embodiment, the user may configure desktop alert management system 100 to logically map all messages from source A (i.e., message-related parameter 116) to alert graphic 118. These alert settings may be provided to desktop alert management system 100 via a user control module. In operation, when messages from source A are received, desktop alert management system 100 may perform a look-up and determine that alert graphic 118 should be displayed. In another embodiment, a source B may specify that all messages of a particular content category (i.e., message-related parameter 120) are to be mapped to alert graphic 122. This information may be passed to desktop alert management system 100 with message 108 or in any other suitable way. Thus, when source B provides a message 108 having the predefined content category, desktop alert management system 100 may determine that alert graphic 122 should be displayed.

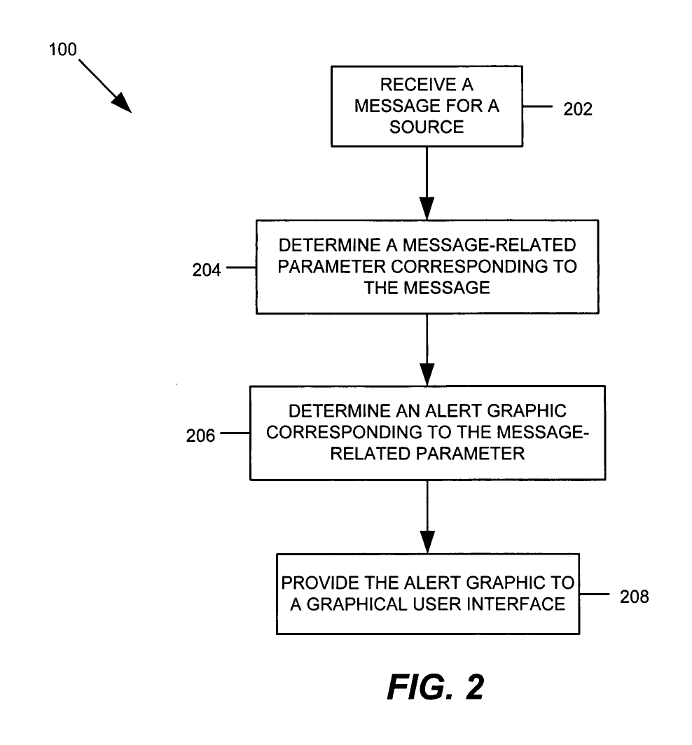

FIG. 2 illustrates the general architecture, operation, and/or functionality of an embodiment of desktop alert management system 100. At block 202, desktop alert management system 100 receives a message 108 associated with a source 106. Message 108 may be received from source 106 or passed to desktop alert management system 100 by an application corresponding to the particular type of message. For instance, if message 108 comprises an e-mail message, message 108 may be received via the e-mail client and then forwarded to desktop alert management system 100 (or vice versa).

At block 204, desktop alert management system 100 determines a message-related parameter 112 corresponding to message 108. At block 206, desktop alert management system 100 determines the alert graphic 114 corresponding to message-related parameter 112. Blocks 204 and 206 represent the logical mapping that enables desktop alert management system 100 to decide which desktop alert to display for any given message. It should be appreciated that the logical mapping may be provided in various ways. For example, in one embodiment, message-related parameter 112 is specified in message 108 by source 106. Source 106 may specify alert graphic 114 (or perhaps the location of alert graphic 114). In this embodiment, desktop alert management system 100 merely executes the logical mapping provided by source 106. For instance, source 106 may embed this information (e.g., a uniform resource locator) in a tag contained in message 108. Desktop alert management system 100 may be configured to interpret the tag, identify the location of alert graphic 114, and download (or otherwise obtain) alert graphic 114.

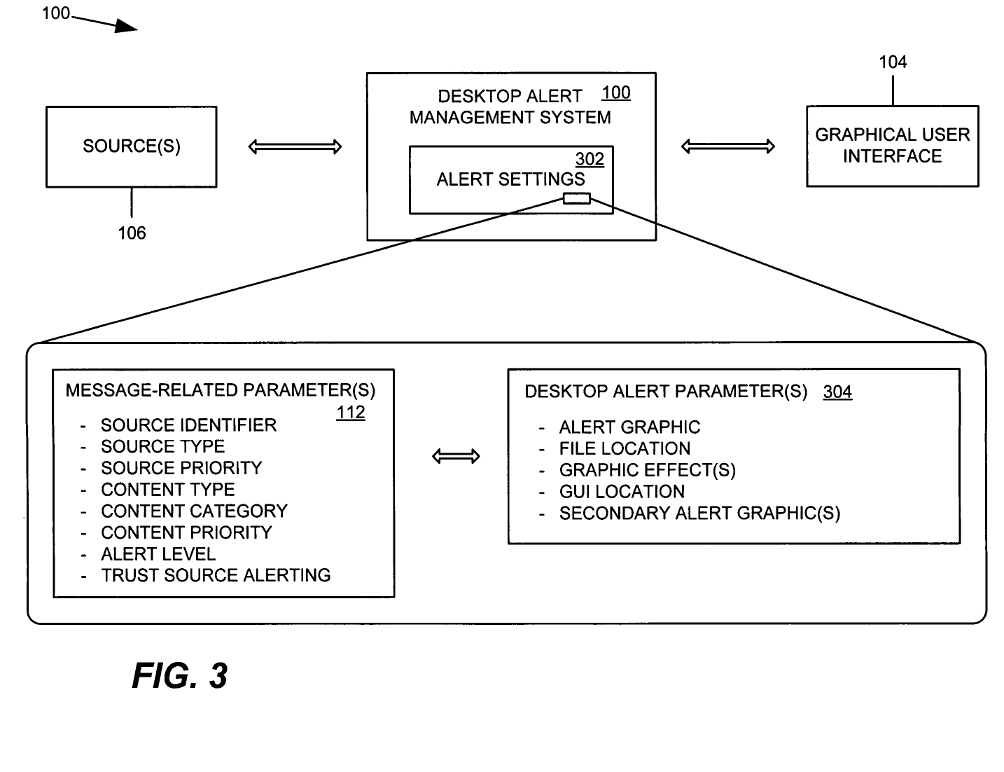

In another embodiment, desktop alert management system 100 determines the logical mapping by referencing various alert setting(s) predetermined by the user. Referring to FIG. 3, alert setting(s) 302 may be stored in memory accessible by desktop alert management system 100. In the embodiment illustrated in FIG. 3, alert setting(s) 302 comprise one or more message-related parameter(s) 112 and corresponding desktop alert parameters 304. Message-related parameter(s) 112 may comprise any of the following, or other, parameters: a source identifier, a source type, a source priority, a content type, a content category, a content priority, and one or more alert levels. One of ordinary skill in the art will appreciate that this list of potential parameter(s) enables the user to define various levels of desktop alerts.

By way of example, the user may configure alert setting(s) 302 so that all messages of a particular content category are flagged and provided to graphical user interface 104. As messages are received, desktop alert management system 100 may determine whether message 108 is in the particular content category and, if so, determine the appropriate alert graphic 114 to be displayed. It should be appreciated that various target criteria may be established depending on the interests or desires of the user. In embodiments where alert level(s) or priorities are specified, message 108 may contain corresponding information, functionality, etc. In this manner, desktop alert management system 100 may access alert setting(s) 302 to determine the target alert criteria and then process message 108 to determine whether the target alert criteria is applicable. Desktop alert management system 100 may also support a “trust source” feature. When this feature is enabled, any alert settings or priorities provided in message 108 are automatically enforced by desktop alert management system 100.

As further illustrated in FIG. 3, desktop alert management system 100 may also access various types of desktop alert parameter(s) 304 to determine the manner in which alert graphic 114 is to be displayed on graphical user interface 104. Desktop alert parameters 304 may include: a file location for alert graphic 114, a particular location on graphical user interface 104 where alert graphic 114 is to be displayed, and a graphic effect to be applied to alert graphic 114. Secondary alert graphic(s) may be defined for a particular alert graphic 114. One of ordinary skill in the art will appreciate that secondary alert graphic(s) may provide a more granular mechanism for controlling desktop alerts. Consider the situation where the user desires to receive a desktop alert for all e-mail messages received from a particular person. For this type of alert, the user may employ a photographic image, computer-generated head shot, etc. of the person (or any suitable avatar) for alert graphic 114. Various anthropomorphic variations of the alert graphic may be used to define secondary alert graphics. In this manner, the secondary alert graphics (and the associated emotions conveyed by the anthropomorphic variations) may be used to provide contextual information about message(s) received from that person.

Referring back to FIG. 2, after the logical mapping is completed, at block 208, desktop alert management system 100 provides the appropriate alert graphic 114 corresponding to message 108 to graphical user interface 104.

In order to further illustrate the principles described above, reference will be made to an exemplary working environment for desktop alert management system 100 and an embodiment of a graphical user interface 402 (FIGS. 4-18). Various aspects of the interaction between graphical user interface 402 and desktop alert management system 100 will be described with reference to incoming messages 108 from five sources 106: news publisher 404; e-mail sender 406; instant messenger sender 408; e-mail sender 410; and news publisher 412. As known in the art, graphical user interface 402 comprises a display screen 414 on which various GUI components may be displayed. The user may interact with the GUI components via a cursor 426. Display screen 414 includes an active window corresponding to a word processing application, a taskbar 416, and a system tray 424. Taskbar 416 includes a start menu 418 that provides an access point to various applications on the computer system. Taskbar 416 also includes quick access to active application windows on the computer system (e.g., e-mail application 420 and word processing application 422). System tray 424 displays various icons associated with other programs, resources, utilities, etc. that are active on the computer system.

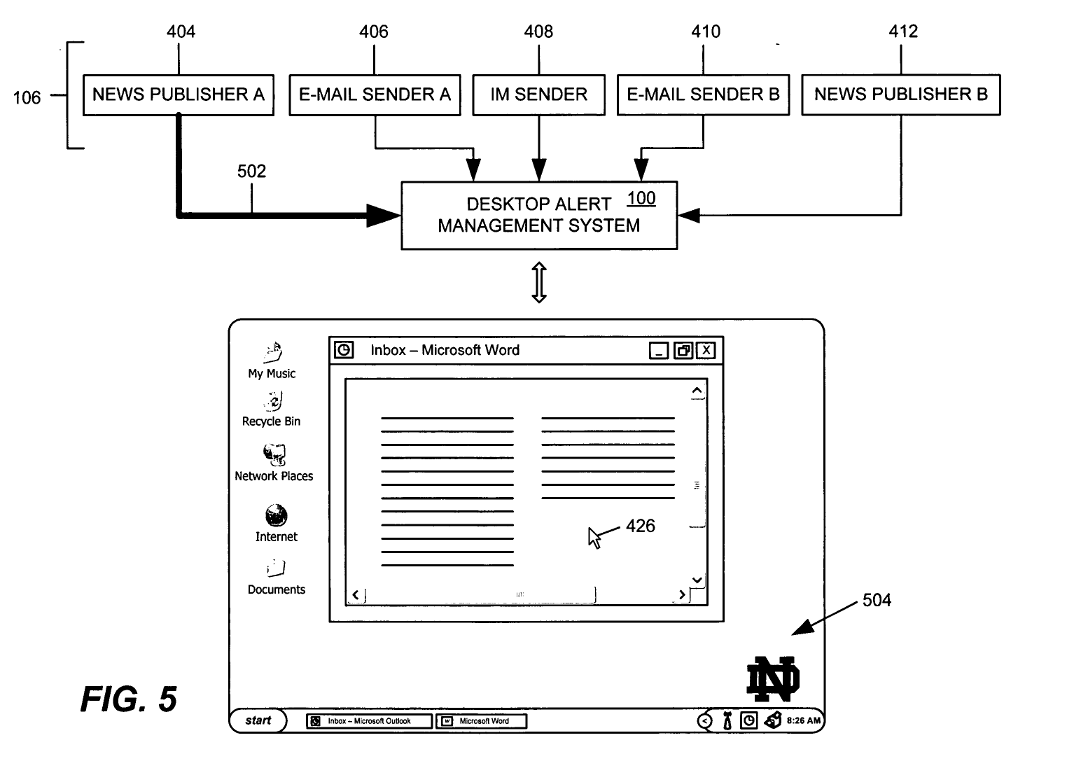

Referring to FIG. 5, desktop alert management system 100 may receive a message 108 from news publisher 404 (bolded line 502). News publisher 404 comprises a news feed service to which the user has subscribed, and the incoming message 108 comprises new content associated with the news feed. As the user is interacting with word processing application 422 via the associated window, desktop alert management system 100 receives the incoming message, determines the appropriate message-related parameter 112, and displays the corresponding alert graphic 114 in the upper right corner of graphical user interface 104. As mentioned above, the position of alert graphic 114 may also be controlled by the user or news publisher 404. In various other embodiments, desktop alert management system 100 may employ default settings for alert graphic 114 or the display location.

As illustrated in FIG. 5, in this example, news publisher 404 is associated with a desktop alert graphic related to the content of the news feed—Notre Dame football. Accordingly, desktop alert management system 100 automatically determines the source or content of the message from news publisher 404 and alerts the user of the new content related to Notre Dame football by displaying an appropriate visual cue—a relatively small image of the easily-identifiable interlocking “ND.” This alert graphic 504 may be defined by the user via alert setting(s) 302 or provided by news publisher 404. Regardless of the manner in which alert graphic 504 is provided and displayed on graphical user interface 104, it should be appreciated that the user may quickly and easily determine that the new content is related to Notre Dame football without much effort because of the familiar association embodied in alert graphic 504. In this manner, the user is non-intrusively notified of the new content from news publisher 404. The user may then determine whether to access the content (e.g., by selecting graphic alert 114) or continue working with word processing application 422.

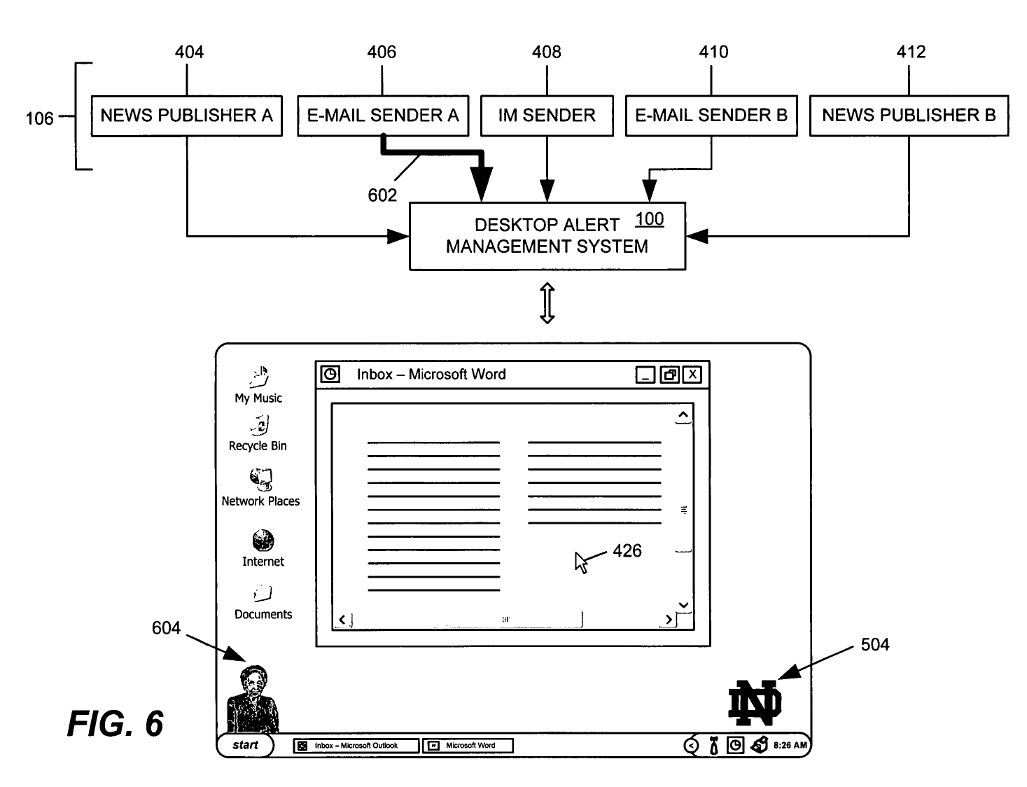

The remaining discussion assumes that the user has elected not to access alert graphic 504 and continues working with word processing application 422. FIGS. 6-9 illustrate another example of an incoming message 108 from e-mail sender 406. In this example, e-mail sender 406 is the user's grandmother. Accordingly, the user has defined an alert graphic 604 comprising a photographic or similar image of the grandmother. As the user continues to interact with word processing application 422, desktop alert management system 100 receives the incoming e-mail message (bolded line 602), determines that the message is from the user's grandmother, and automatically displays the corresponding alert graphic 604 in the lower left corner of graphical user interface 104.

Again, due to the familiar association embodied in alert graphic 604, the user may quickly and easily determine that there is a new e-mail message from his/her grandmother. The user may then determine whether to access the e-mail or continue working with word processing application 422. Due to the infrequency of incoming messages from his/her grandmother, for example, the user may immediately place a high priority on this message and decide to access the message.

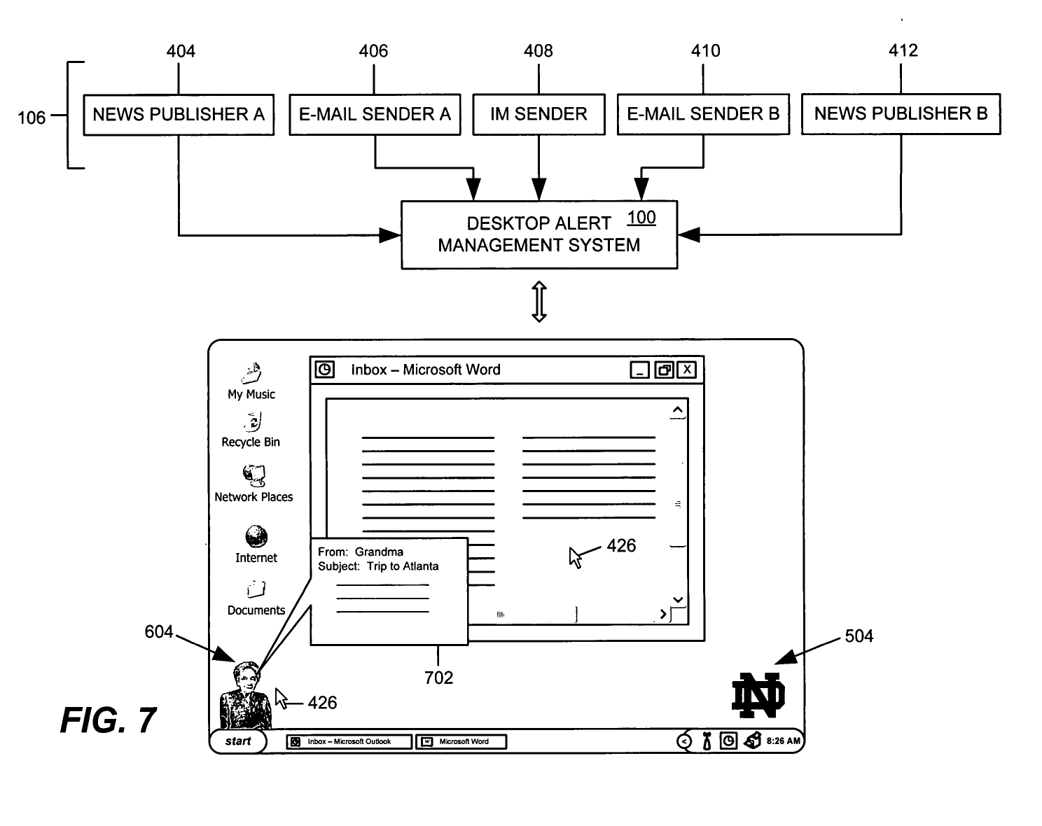

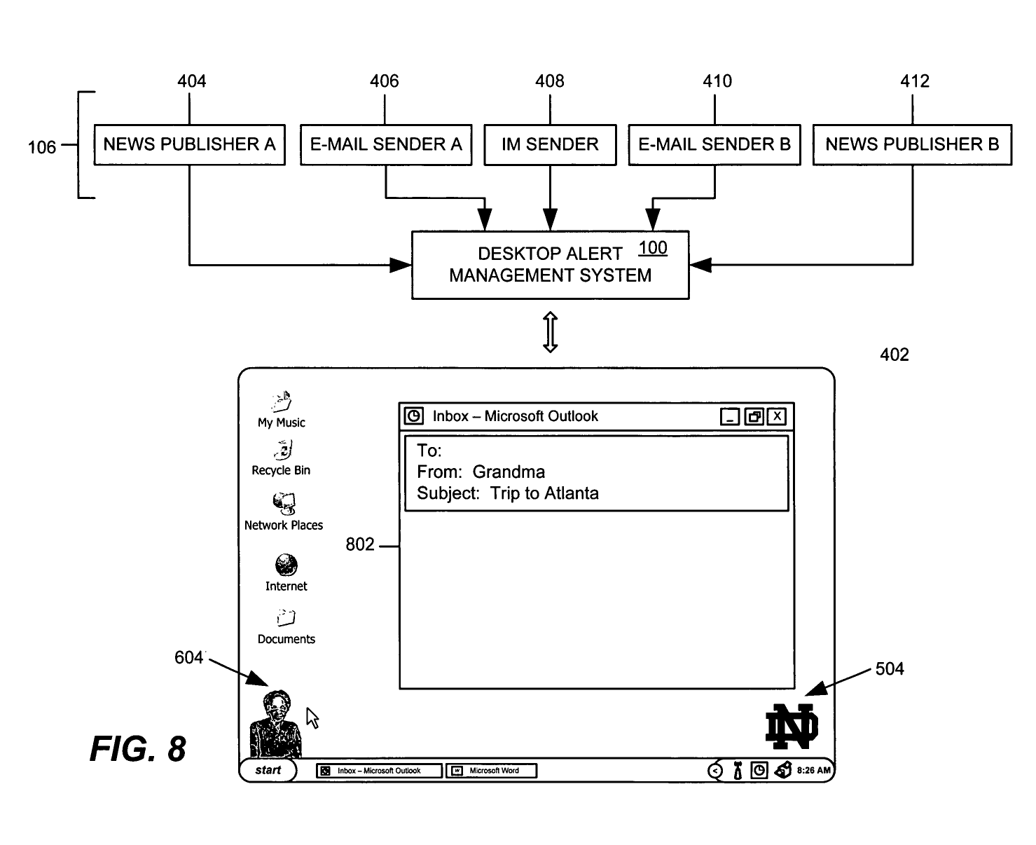

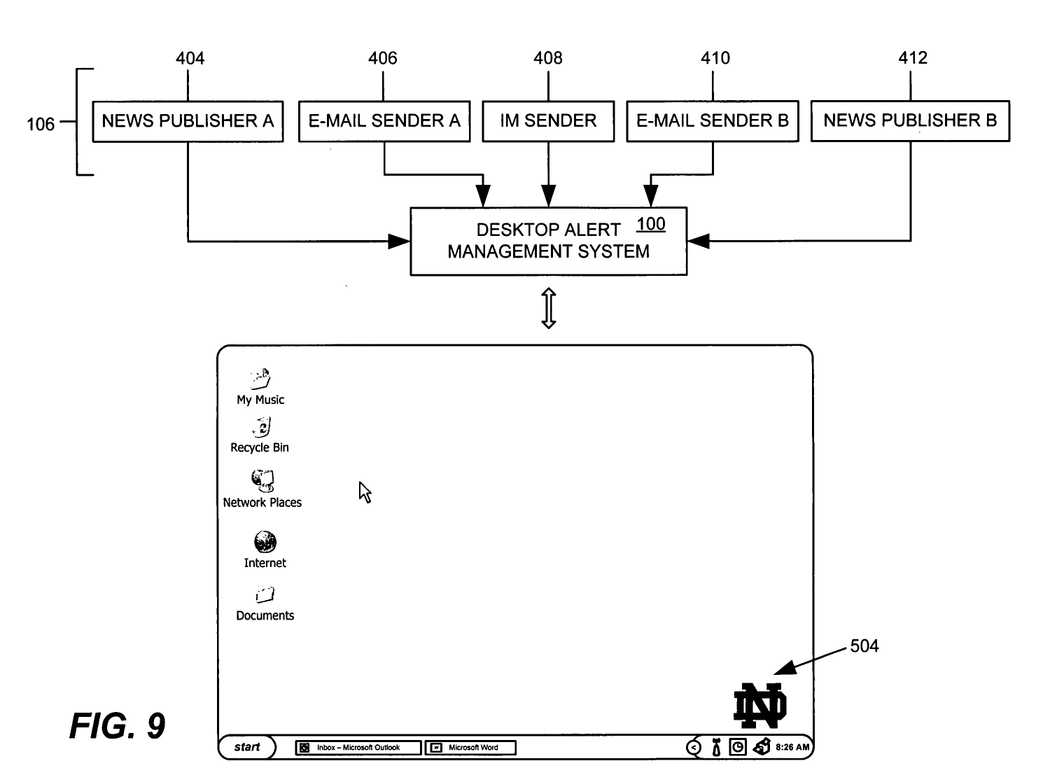

It should be appreciated that the content associated with an alert graphic 114 may be accessed in a number of ways. In the embodiment illustrated in FIG. 7, the user moves cursor 426 on or near alert graphic 604 and engages the image object. In response to the selection of alert graphic 604 (e.g., right-clicking a mouse, double-clicking a mouse, a mouse-over, etc.), desktop alert management system 100 may display the message as a thought balloon 702 to allow the user to easily read the message. FIG. 8 illustrates an alternative embodiment in which the message is displayed in an application window associated with the e-mail client on the computer system. Regardless of the method of displaying the message, after the user is finished with the message, desktop alert management system 100 may determine that the message has been appropriately reconciled. As illustrated in FIG. 9, desktop alert management system 100 may remove alert graphic 604 from graphical user interface 104 after the message has been reconciled.

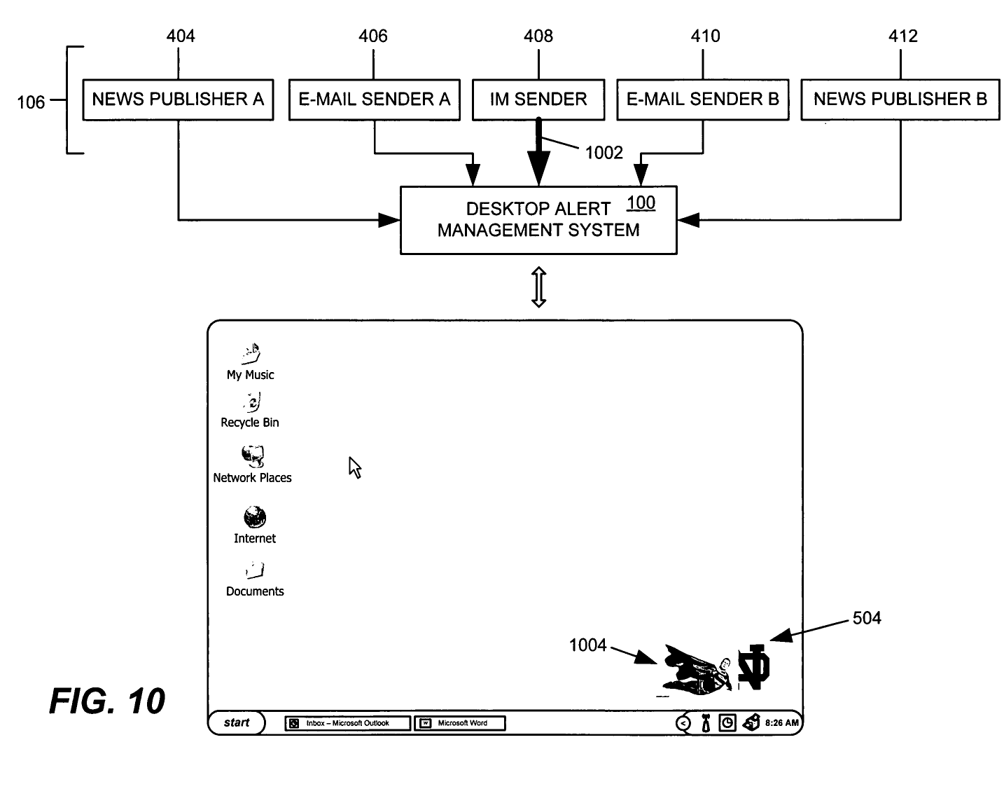

After alert graphic 604 is removed, the user may receive another message. As represented by bolded line 1002 in FIG. 10, the user may subsequently receive an instant message (IM) from a particular user. In this example, IM sender 408 may desire to be associated with a novel desktop alert graphic 1004—an image of the comic hero Superman. Desktop alert management system 100 receives the incoming IM message from sender 408 and determines that alert graphic 1004 should be used for alerting the user. As mentioned above, when the source 106 desires to control the desktop alert graphic to be displayed on graphical user interface 104, appropriate information (e.g., file location, GUI position, etc.) may be passed to desktop alert management system 100 along with message 108.

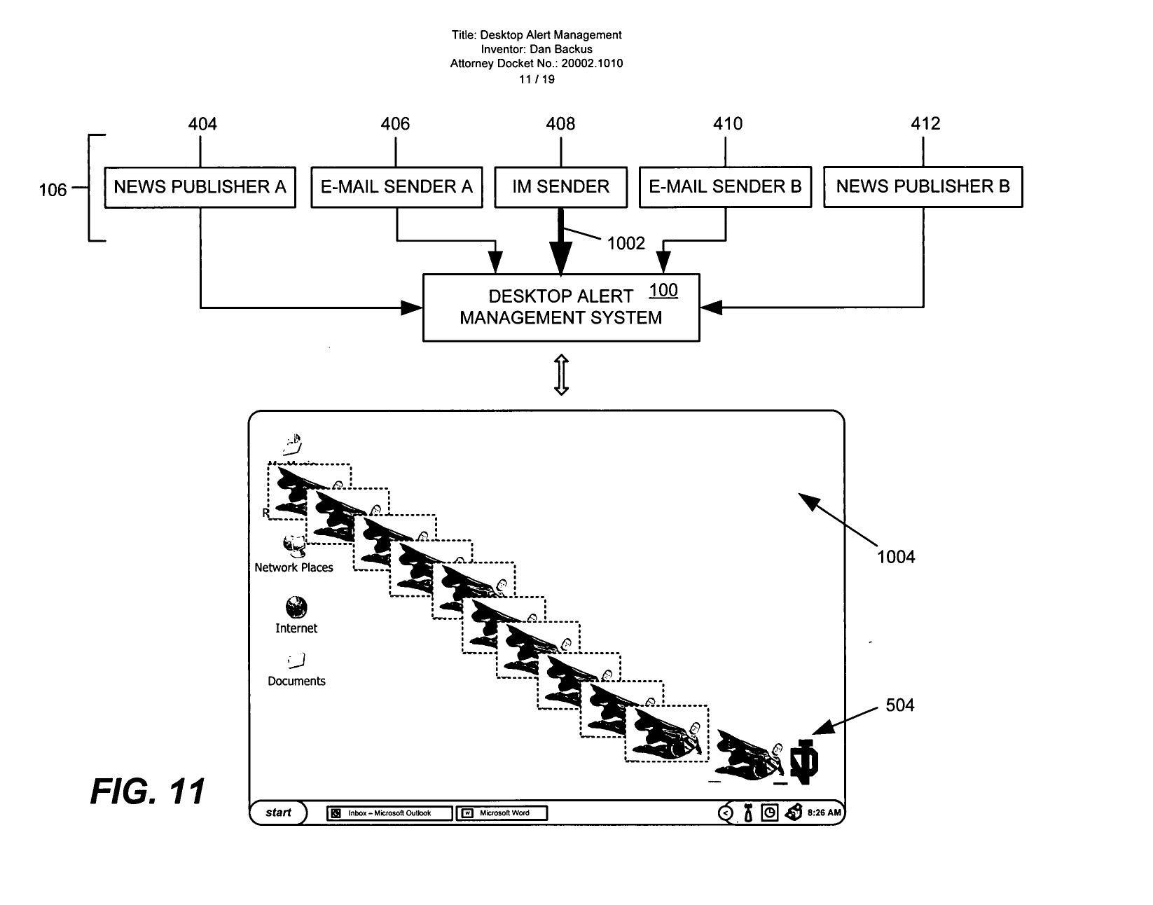

FIG. 11 illustrates an alternative method for displaying alert graphic 1004. In this embodiment, alert graphic 1004 has an associated graphical effect that defines the desired effect by which the alert graphic will be presented to graphical user interface 104. As illustrated in FIG. 11, alert graphic 1004 may be associated with a graphics effect whereby the graphic is initially displayed in the upper left corner of display screen 414 and then diagonally moved to the lower right corner. This and other effects may provide a unique and eye-catching way for sources 106 to represent themselves for desktop alerts. It should be appreciated that any visual effect may be achieved. Furthermore, any particular desktop alert may be accompanied by sound alert(s) to supplement the alert.

In order to conserve real estate on display screen 414, desktop alert management system 100 may layer alert graphics 114 on top of each other. For example, in the embodiment of FIG. 11, alert graphic 1004 is displayed over previous alert graphic 504. Desktop alert management system 100 may employ this layering effect in combination with a priority or buffering scheme to present alert graphics in a manner to communicate the order in which alert graphics are received, the relative priority of alerts, etc. Because of the familiar characteristics of alert graphics 114, it should be appreciated that the user may be able to discern the identity of a particular graphic by viewing only a portion of the graphic. As illustrated in FIG. 11, the user may be able to discern the underlying alert graphic 504 even when alert graphic 1004 covers a substantial portion of the graphic.

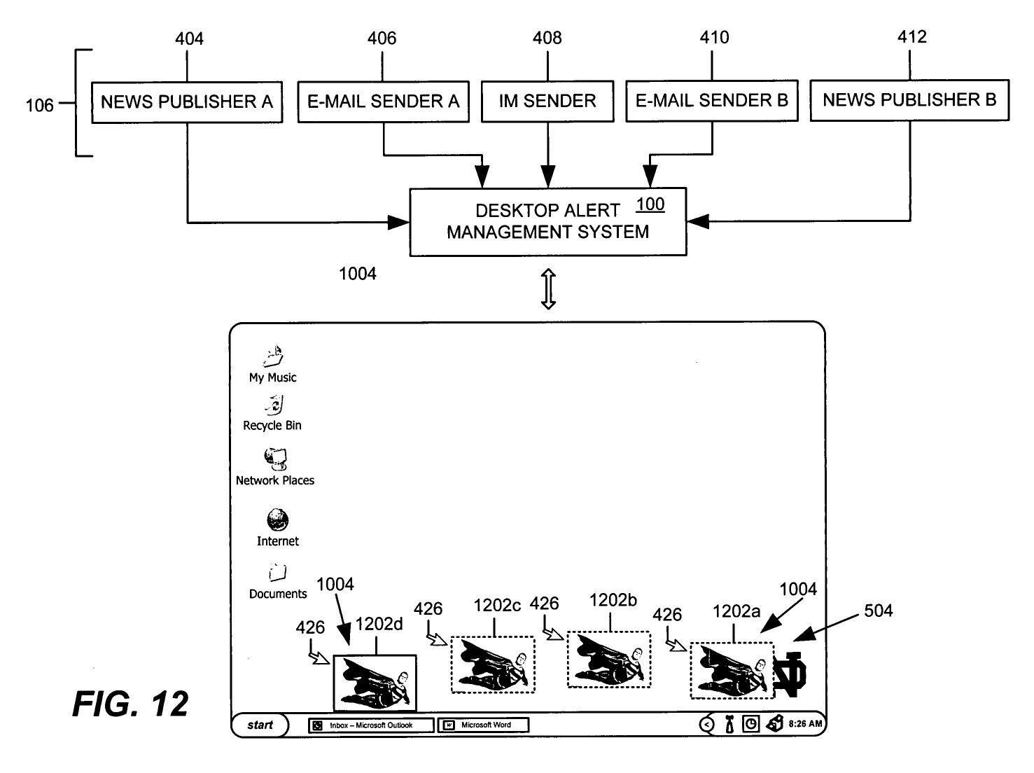

The layering effect may be implemented as a default for particular types of alert graphics or groups of sources/content where it is desirable to present more information in less space. It should be appreciated, however, that the user may disable the layering effect by automatically relocating an alert graphic. As illustrated in FIG. 12, the user may place cursor 426 over alert graphic 1004, select the graphic (or otherwise engage the alert relocation functionality), and drag alert graphic to a new location on display screen 414 (e.g., any of positions 1202a-d in FIG. 12). Desktop alert management system 100 automatically determines this user interaction and updates alert setting(s) 302.

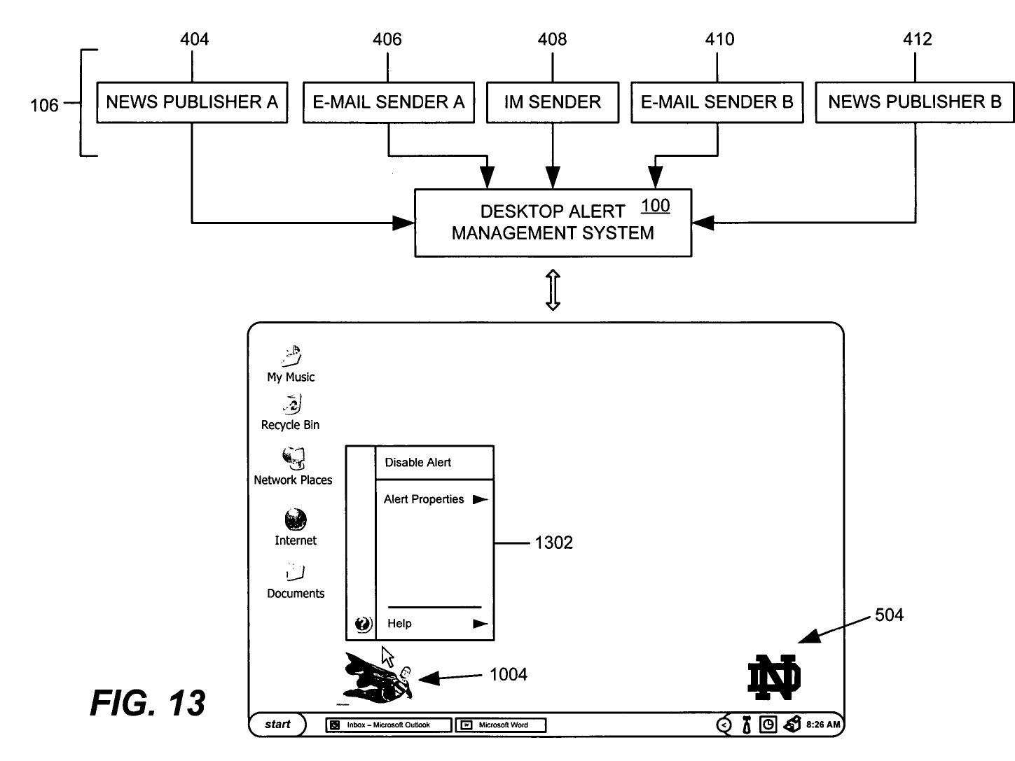

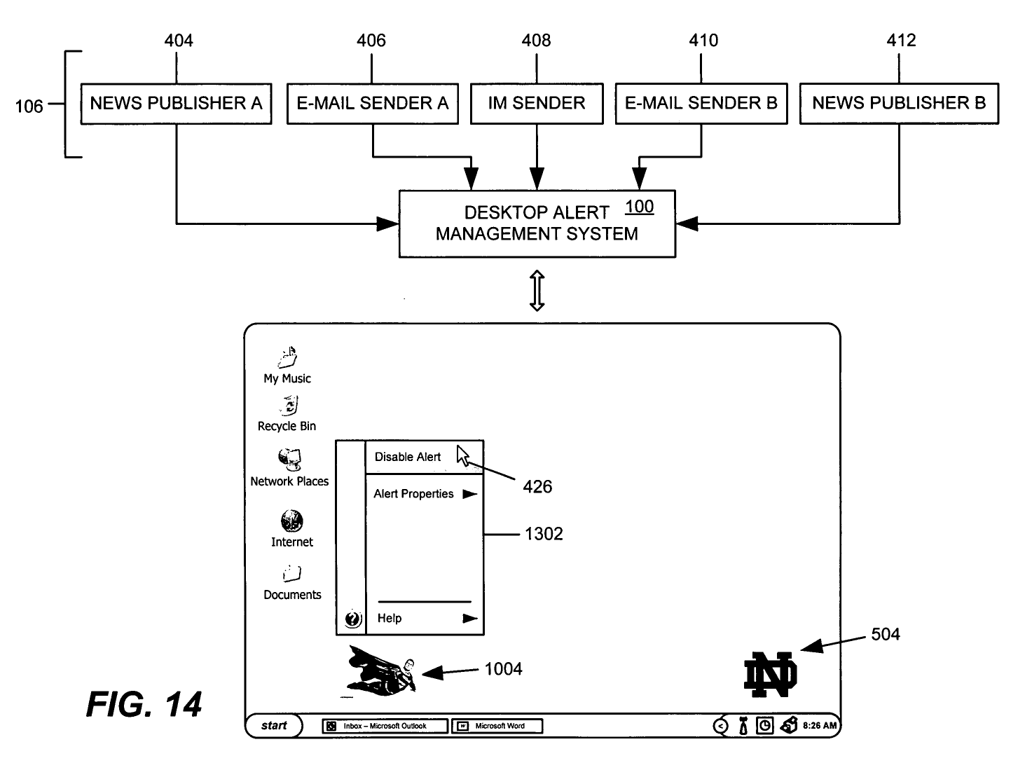

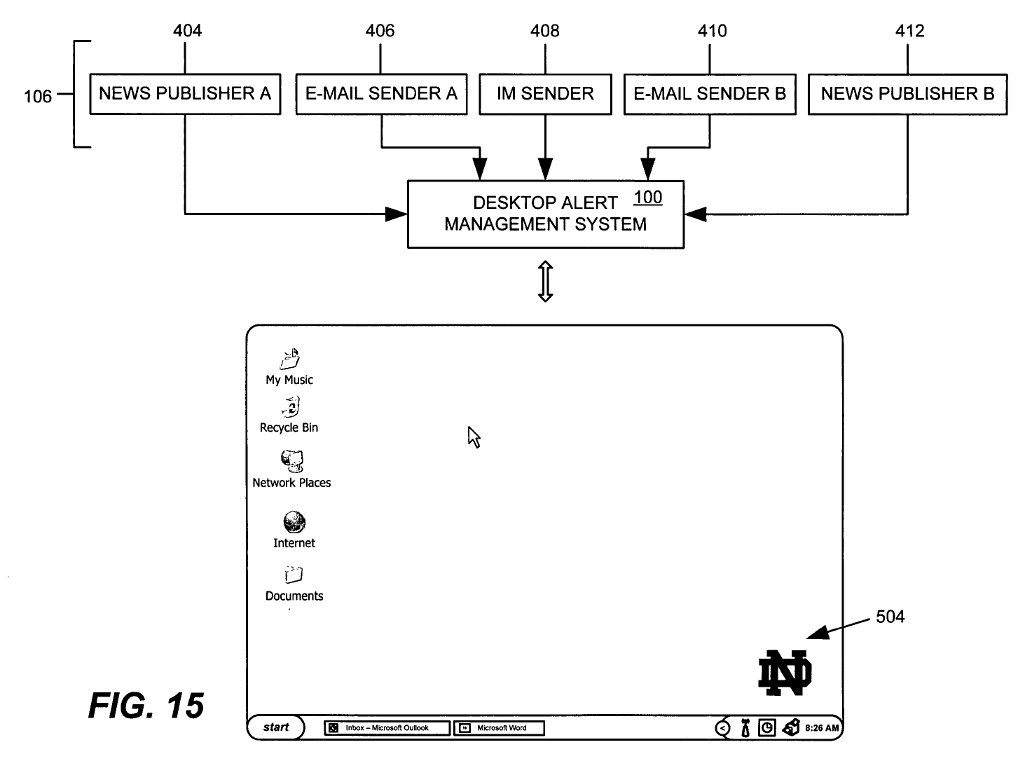

FIGS. 13-15 illustrate an alternative mechanism for reconfiguring alert setting(s) 302. In this embodiment, desktop alert management system 100 provides alert graphic 1004 as a self-contained object that enables the user to alter the alert settings by engaging the underlying alert graphic via cursor 424. For example, the user may easily update the settings for the desktop alert by performing a right mouse click over alert graphic 1004. As illustrated in FIG. 13, this or other GUI-type actions, commands, etc. may open a window 1302 by which a user may elect to disable the alert or alter the alert settings. The user may disable the alert by highlighting and clicking a “Disable Alert” command (FIG. 14), which removes the associated alert graphic 1004 (FIG. 15) and disables any future alerts for IM sender 408.

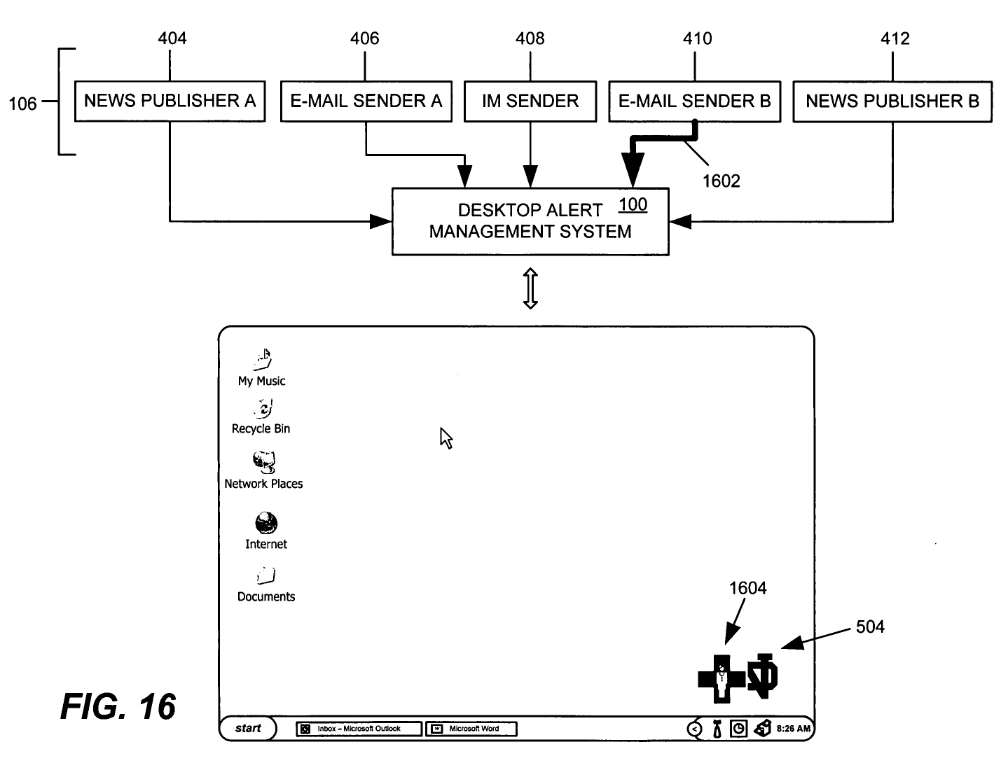

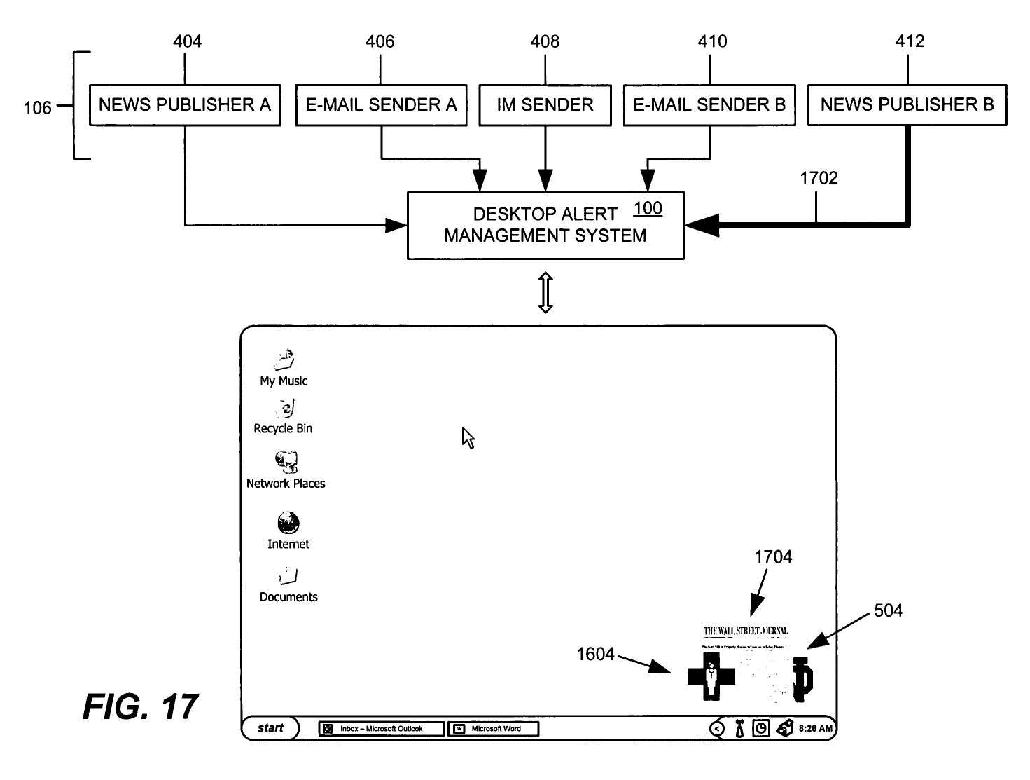

As mentioned above, desktop alert management system 100 may support a layering effect integrated with a priority scheme to communicate the order in which messages are received or the relative priority of messages. An example of this functionality is illustrated in FIGS. 16 and 17. Desktop alert management system 100 may receive a new message 108 from e-mail sender 410 (bolded line 1602—FIG. 16). In this example, e-mail sender 410 may be the user's doctor. When the new message 108 is received, desktop alert management system 100 determines that alert graphic 1604 is to be used for the desktop alert. Based on a logical priority scheme (which may be specified by the user of e-mail sender 410), desktop alert management system 100 may determine that the message from the doctor is of higher importance, relevance, etc. than the message from news publisher 404. Therefore, desktop alert management system 100 may automatically display alert graphic 1604 over alert graphic 504—thereby communicating relative priority between the two messages.

Subsequently, desktop alert management system 100 may receive a new message 108 from another news publisher 412. Desktop alert management system 100 determines that the new message 108 is from news publisher 412 and displays a suitable visual cue to indicate the source, content, etc.—alert graphic 1704 representing content from the Wall Street Journal. Prior to displaying alert graphic 1704, however, desktop alert management system 100 may compare the alert level(s), priorities, etc. corresponding to each message. In this instance, the message from the user's doctor may be given a higher priority or alert level, in which case desktop alert management system 100 determines this relative priority. Based on the comparison, desktop alert management system 100 may determine that alert graphic 1704 should not be layered over previous alert graphic 1604. Instead, desktop alert management system 100 may insert alert graphic 1704 behind alert graphic 1604. It should be appreciated that various combinations of message-related parameter(s) 112 and desktop alert parameter(s) 304 (FIG. 3) may be created to provide any desirable alerting scheme.

Desktop alert management system 100 may also support an alert grouping feature, which enables the user to manage groups of desktop alerts based on the location of the alert on graphical user interface 104. In other words, desktops alerts of a particular type (or that match predefined criteria) may be positioned on a predetermined portion or location of display screen 414. From the user perspective, the location of the desktop alert communicates information about the desktop alert.

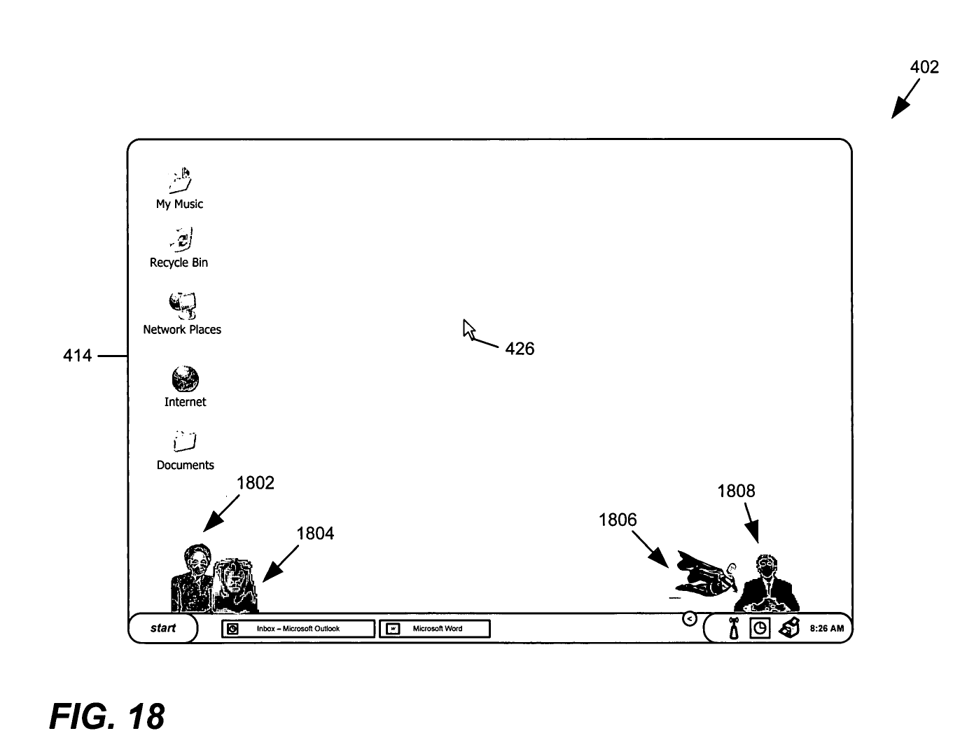

An embodiment of the alert grouping feature is illustrated in FIG. 18. In the embodiment of FIG. 18, the user has specified two alert groups: a personal alert group located in the lower left portion of display screen 414; and a business alert group located in the lower right portion of the display screen 414. The personal alert group may be used to display, for example, desktop alerts related to new e-mail messages from family or friends or news feeds related to areas of personal interest. The business alert group may be used to display, for example, desktop alerts related to new e-mail messages from co-workers or news feeds related to areas of professional interest. As illustrated in FIG. 18, the user has received two personal alerts (alert graphics 1802 and 1804) and two business-related alerts (alert graphics 1806 and 1808). It should be appreciated that the alert grouping feature enables the user to quickly discern information about the particular desktop alert based on the location of the alert graphics.

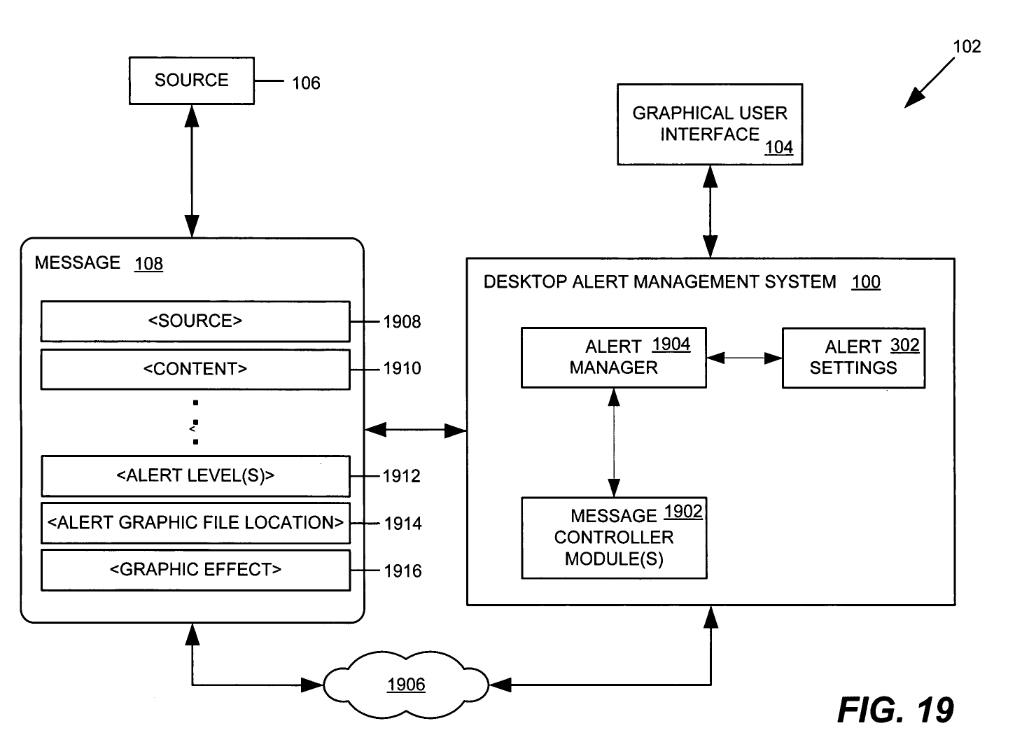

FIG. 19 illustrates another embodiment of a system 102 for implementing desktop alert management system 100. In this embodiment, desktop alert management system 100 comprises message controller module(s) 1902, an alert manager 1904, and alert setting(s) 302. In general, message controller module(s) 1902 include the functionality, logic, etc. for communicating with sources 106. Message controller module(s) 1902 may be configured to push or pull messages 108 from sources 106 in a variety of suitable ways depending on any number of variables, applications, etc. Regardless of the manner in which messages are provided to desktop alert management system 100, alert manager 1904 comprises the functionality, logic, etc. for determining the manner in which desktop alerts are to be provided to graphical user interface 100. As described above, this logical mapping may be performed in various ways. In one embodiment, alert manager 1804 accesses alert setting(s) 302 to determine which alert graphic to display (or whether to perform a desktop alert for the message 108).

In another embodiment, alert manager 1904 and/or message-controller module(s) 1902 employ message tags to perform desktop alerting. As illustrated in FIG. 18, a message 108 may include various types of tagged information that may be interpreted by desktop alert management system 100. For example, message 108 may include any of the following, or other, tags: a source tag 1908; a content tag 1910; an alert level(s) tag 1912; an alert graphic location tag 1914; and a graphic effect tag 1916. Source tag 1908 may comprise a source identifier indicating the identity of source 106. Content tag 1910 may comprise the underlying message or other alert-related information to display to the user. Alert level(s) tag 1912 may comprise various types of information for implementing an alert level scheme, priority scheme, etc. or, in some embodiments, may be used to implement the trust source feature described above.

Tags 1914 and 1916 may be used to manage alert graphics 114 in a convenient manner. For example, tags 1914 and 1916 may be used to specify the location of the particular alert graphic 114, a corresponding graphics effect or, in some embodiments, secondary alert graphics. As mentioned above, this information may be passed to desktop alert management system 100 using the corresponding tags. In this manner, a source 106 may leverage the services of desktop alert management system 100 to control desktop alerts. Tags 1914 and 1916 may be particularly useful when source 106 communicates with desktop alert management system via a communications network 1806. For example, a news publisher that frequently provides new content to desktop alert management system 100 may use tags 1914 and 1916 to identify the location of the associated graphics, effects, etc. by referencing a uniform resource locator (URL) in message 108. Rather than downloading the graphics for each new message 108, desktop alert management system 100 may reference the tagged information to determine whether there is a local (e.g., cached) copy of the graphics. Furthermore, the news publisher may easily change the desktop alert settings for a particular message by changing the corresponding URL. Desktop alert management system 100 may compare the tagged information to determine whether it has changed. If there is no change, desktop alert management system 100 may use the prior data. However, if the news publisher changes the settings for the new message 108, desktop alert management system 100 may easily compare the URL to the stored information and, if different, obtain the new data by downloading it from the appropriate URL.

One of ordinary skill in the art will appreciate that desktop alert management system 100 may be implemented in software, hardware, firmware, or a combination thereof. Accordingly, in one embodiment, desktop alert management system 100 is implemented in software or firmware that is stored in a memory and that is executed by a suitable instruction execution system. In hardware embodiments, desktop alert management system 100 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be further appreciated that the process descriptions or functional blocks in FIGS. 1-19 represent modules, segments, or portions of logic, code, etc. which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, desktop alert management system 100 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although this disclosure describes various embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A desktop alert management system for controlling alerts displayed on a graphical user interface, the desktop alert management system comprising:
a message controller module for controlling communication between a graphical user interface and at least one source, the message controller module configured to receive a message from the at least one source; and
an alert manager for determining an alert graphic associated with the message from the at least one source, the alert graphic to be displayed on the graphical user interface for a desktop alert associated with the message.

2. The desktop alert management system of claim 1, wherein the message is initiated by the at least one source.

3. The desktop alert management system of claim 1, wherein the message controller module receives the message in response to a request from the desktop alert management system.

4. The desktop alert management system of claim 1, wherein the alert manager is configured to determine the alert graphic associated with the message based on information contained in the message.

5. The desktop alert management system of claim 1, wherein the message contains a reference to the alert graphic.

6. The desktop alert management system of claim 5, wherein the reference to the alert graphic comprises a uniform resource locator where the alert graphic is stored.

7. The desktop alert management system of claim 1, wherein the alert graphic further comprises a graphics effect to be used when displaying the alert graphic on the graphical user interface.

8. The desktop alert management system of claim 1, wherein the alert graphic is specified by the source.

9. The desktop alert management system of claim 1, further comprising a user control module that enables a user to specify the alert graphic associated with the message.

10. A computer system comprising:
a graphical user interface; and
a desktop alert management module for controlling alerts provided to the graphical user interface, the desktop alert management module comprising:
logic configured to receive a message associated with a source;
logic configured to determine a parameter corresponding to the message;
logic configured to determine an alert graphic associated with the parameter; and
logic configured to provide the alert graphic to the graphical user interface.

11. A method for providing alerts to a desktop, the method comprising:
receiving a message from a source;
determining a message-related parameter corresponding to the message; and
identifying an avatar associated with the message-related parameter.

12. The method of claim 11, further comprising displaying the avatar on a graphical user interface.

13. The method of claim 11, wherein the avatar is specified by the source.

14. The method of claim 11, wherein the avatar comprises an alert graphic defined by a user.
